(19) United States
(12) Patent Application Publication
(10) Pub. No.: US 2010/0166993 A1
(43) Pub. Date: Jul. 1, 2010

(54) REINFORCEMENT LAYER MADE OF HYBRID CORDS FOR ELASTOMERIC PRODUCTS

(75) Inventors: Wolfgang Reese, Peine (DE); Claus Van Barneveld, Garbsen (DE); Carole Justine, Wunstorf (DE); Birgit Freitag, Ronnenberg (DE)

Correspondence Address: LERNER GREENBERG STEMER LLP, P O BOX 2480, HOLLYWOOD, FL, 33022-2480, US

(73) Assignee: CONTINENTAL REIFEN DEUTSCHLAND GMBH, Hannover (DE)

(21) Appl. No.: 12/722,578

(22) Filed: Mar. 12, 2010

Related U.S. Application Data
(63) Continuation of application No. PCT/EP2008/061108, filed on Aug. 26, 2008.

(30) Foreign Application Priority Data
Sep. 15, 2007 (DE) 10 2007 044 153.5

(51) Int. Cl. D02G 3/02; F01B 19/00; B65G 15/34; B60C 9/00; B29D 30/00; B32B 1/08

(52) U.S. Cl. 428/36.1; 57/244; 92/47; 198/847; 156/110.1; 152/451; 152/527; 152/540; 428/222

(57) ABSTRACT

A reinforcement layer for elastomeric products is formed of hybrid cords that are arranged substantially parallel to each other within the layer. The hybrid cords are composed of a first twisted textile yarn made of a first material and a second twisted textile yarn made of a second material. The ends of the two yarns are twisted with each other. The first twisted textile yarn is a polyketone yarn and the second twisted textile yarn is a polyester yarn.

### CROSS-REFERENCE TO RELATED APPLICATION

This application is a continuation, under 35 U.S.C. §120, of copending international application No. PCT/EP2008/061108, filed Aug. 26, 2008, which designated the United States; this application also claims the priority, under 35 U.S.C. §119, of German patent application No. 10 2007 044 153.5, filed Sep. 15, 2007; the prior applications are herewith incorporated by reference in their entirety.

### BACKGROUND OF THE INVENTION

### Field of the Invention

This invention relates to a strength element ply composed of a hybrid cord for elastomeric articles of manufacture and to the use of such a strength element ply particularly for pneumatic vehicle tires, but also in conveyor belts, flat belts, flexible woven-fabric tubes and air bellows.

Strength elements for reinforcing various elastomeric articles of manufacture are well known. In the context of pneumatic vehicle tires, for instance, it is known to use a belt bandage which has a single-ply or multiple-ply construction, covers at least the belt edges, and contains strength elements, which extend in a parallel manner and essentially in the circumferential direction, in the form of cords embedded in rubber. This belt bandage has the purpose, particularly in high-speed use, to prevent the tire from undergoing a rise due to the centrifugal forces arising in operation.

In the course of tire production, the bandage is applied in the form of plies with strength elements embedded in a unvulcanized rubber mixture which are wound onto the belt. The strength elements for such plies are embedded in rubber by a sheet of essentially parallel thread-shaped strength elements, which are generally pretreated thermally and/or with impregnation for better adherence to the embedding rubber in a manner known to one skilled in the art, passing in the longitudinal direction through a calender or an extruder for sheathing with the rubber mixture. In the course of shaping with existing apparatus and the vulcanization of the tire, the tire generally expands in the shoulder region, due to the rise by up to 2% and in the center region by up to 4% compared with the unvulcanized green tire when the green tire is wound on a flat drum. With more recent building drums, elongation during tire production is required to be still lower at about not more than 2%. The rise is lower with more recent apparatus.

The cords of the bandage shall allow a sufficient rise in shaping and in the vulcanization mold during tire production in order that the tire may be precisely formed, and they shall ensure, after the tire is finished, good high-speed utility in operation. To meet these requirements, the cords should be extendable with moderate force up to a strain of about 4% and require a very much higher force to be extendable to a higher strain.

Conveyor belts are endless belts which contain as a primarily important feature a strength element. The latter is usually composed of woven fabric plies, constructed from identical and/or are variety of different cord materials. The woven cord fabric is exposed to severe mechanical stresses even in the course of the manufacture of the conveyor belts. The cord fabric is frictionized or doughed in order that it may be rendered adherence-friendly to the coating layer and thereafter both-sidedly coated in a calender, repeatedly doubled and finally calendered with the top layer. Conveyor belts generally have to be able to withstand appreciable stresses due to high transportation rates, which is why there is typically a need for substantial use of a strength element.

Flat belts have a traction element formed from a strength element ply consisting of cabled cord threads. The cord threads embedded in a rubber matrix are protected by one or two rubberized wrapping fabrics. The cord is intended to enable the flat belt to transmit high forces at low strains. This also holds for flexible woven-fabric tubes, which are exposed to high internal and external pressures and therefore are reinforced by a suitable strength element ply composed of a woven cord fabric or of individual cord threads. When incorporating cord into the flexible woven-fabric tubes, it is important to apply the cord threads at certain angles in order to prevent lengthening and thinning or widening and shortening.

Air bellows constructed from one or more rubber matrices similarly need reinforcement by a strength element ply constructed from cords, to partially absorb the stresses due to compression, traction or shearing. The strength element ply constructed from cords must again provide high transmission of force coupled with very low strain.

The following patent-related literature is of particular interest with regard to the invention: Published patent application US 2003/175490 A1 (corresponding DE 602 11 707 T2); U.S. Pat. No. 7,188,654 B2 (cf. corresponding European patent EP 1 475 248 B1); and published patent application US 2005/0126673 A1.

US 2003/175490 A1 discloses a hybrid cord having excellent flexural stability and dimensional stability for use in the reinforcement of rubber products. The hybrid cord consists of glass fibers and aramid fibers, which each have been subjected to a resorcinol-formaldehyde-latex (RFL) treatment.

U.S. Pat. No. 7,188,654 B2 describes a strength element ply for the belt bandage of pneumatic vehicle tires, wherein the strength elements are hybrid cords which are constructed from a first yarn having a high modulus of elasticity and a second yarn having a low modulus of elasticity. The first yarn of the hybrid cord is an aramid yarn, while the second yarn of the hybrid cord is a nylon yarn.

US 2005/0126673 A1 discloses a pneumatic tire comprising a strength element cord composed of aliphatic polyketone fibers. A hybrid cord is not mentioned in the published patent application.

### SUMMARY OF THE INVENTION

It is accordingly an object of the invention to provide a reinforcement layer formed of hybrid cords for elastomeric products which overcomes the above-mentioned disadvantages of the heretofore-known devices and methods of this general type and which provides for a strength element ply which is constructed from cords and which is able to ensure a higher force transmission, compared with the prior art, coupled with low strain. It is a further object of the invention to provide a strength element ply in the manufacture of pneumatic vehicle tires in particular, but also of conveyor belts, flat belts, flexible woven-fabric tubes, and air bellows.

With the foregoing and other objects in view there is provided, in accordance with the invention, a strength element ply (i.e., a reinforcement laye) for elastomeric articles of manufacture, comprising:

strength elements formed of hybrid cords disposed in a substantially parallel arrangement within the ply; and

said hybrid cords being formed of polyketone yarn forming a first twisted textile yarn and of polyester yarn forming a second twisted textile yarn;

wherein said first twisted textile yarn of polyketone and said second twisted textile yarn of polyester are end-twisted together.

In other words, we have found that the objects of the invention are achieved by providing a strength element ply wherein the strength elements are constructed from a hybrid cord which form a substantially parallel arrangement within the ply and are constructed from a first twisted textile yarn of a first material and from a second twisted textile yarn of a second material which are end-twisted together. The first twisted textile yarn is a polyketone yarn and the second twisted textile yarn is a polyester.

It is surprising, particularly in relation to the use of the strength element ply in pneumatic vehicle tires, that the combination of polyketone yarn and polyester yarn in a hybrid cord provides sufficient extensibility during the tire-producing step of shaping, so that the green tire is precisely formable and additionally has good high-speed utility. The conventional use of aramid yarns and cords in a strength element ply evinces a particularly high modulus of elasticity and displays the advantage of non-shrinkage and of low plastic deformation in the ready-produced tire. During tire building, by contrast, strength element plies thus constructed prove to be disadvantageous, since their extensibility is too low, so that the green tire is only insufficiently formable and as a result only poor tire uniformity is obtained. This problem also presents for example in the manufacture of flexible woven-fabric tubes and air bellows, while with the use of aramid as cord materials for conveyor belts and flat belts it is the absent force transmission at low strain in the industrial use of the conveyor belts and flat belts that must be considered more relevant.

The present strength element ply composed of a hybrid cord consisting of polyketone and polyester yarns, by contrast, has better extensibility than an aramid cord and lower shrinkage than nylon cord, and moreover polyketone is comparatively inexpensive in acquisition compared with aramid. The extensibility of the hybrid cords can be controlled via suitable, conventional drawing, in which case it is advantageous that a 1-bath operation is sufficient for a hybrid cord of polyketone and polyester yarns. By comparison, strength element plies consisting of cords of other materials usually require more than a 1-bath operation in that a 2-bath operation has to be used, which takes longer and is more costly.

In accordance with an advantageous feature of the invention, the first twisted textile yarn is a polyketone yarn and the second twisted textile yarn is a polyester yarn selected from the group consisting of polyethylene terephthalate (PET) and/or polyethylene naphthalate (PEN) and/or polybutylene terephthalate (PBT) and/or polycarbonate (PC).

The term “polyketone” refers to a polyolefin ketone which is a condensation product of ethene and carbon monoxide.

It is further advantageous when the first twisted textile yarn and/or the second twisted textile yarn have/has a linear density in the range from 400 to 2200 dtex. This therefore creates a comparatively fine hybrid cord which, owing to its low weight, but also owing to its above-described advantageous material properties such as the strength of both the yarns of the hybrid cord of the present invention, little if any shrinkage on the part of the cord and good attachability of the cord to a rubber matrix, enhances the mechanical properties necessary for use of the aforementioned elastomeric products. In the case of tires, this applies particularly to the running properties of ultrahigh performance (UHP) tires. The difference in linear density between the two yarns should be kept as small as possible in order to obtain a very uniform cord which has good processing properties and which has good retained strength after fatiguing. Advantageously, the two yarns forming the cord have the same linear density.

In accordance with an added feature of the invention, the two yarns forming the hybrid cord are end-twisted at a twisting rate of 150 to 600 t/m, preferably at 340 to 480 t/m.

To ensure reliable adherence of textile strength elements to the rubber, it is advantageous to provide the textile hybrid cords with an adhesive impregnation, for example with an RLP dip in a 1-bath or 2-bath operation.

When at least one of the above-described strength element plies is used in a pneumatic vehicle tire, preferably as a belt bandage, the tire will have particularly good high-speed utility and flatspotting is substantially reduced.

When the above-described strength element ply is used as a bead reinforcer in a pneumatic vehicle tire, the advantage is that the hybrid strength elements have a higher modulus than hitherto customarily used nylon strength element plies, that adherence to the rubber is improved, and there is likewise a cost advantage.

These advantages are also achieved when the above-described strength element ply is used in the manufacture of further elastomeric articles of manufacture, such as conveyor belts, flat belts, flexible woven-fabric tubes and air bellows.

Other features which are considered as characteristic for the invention are set forth in the appended claims.

Although the invention is described herein as embodied in reinforcement layer made of hybrid cords for elastomeric products, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific exemplary embodiments.

### DETAILED DESCRIPTION OF EXAMPLES OF THE INVENTION

A polyketone yarn based on a multifil polyolefin ketone yarn having a linear density of 1670 dtex, Z-twisted at 340 T/m first twist, and a polyester yarn having a linear density of 1440 dtex, Z-twisted at 340 T/m first twist, were end-twisted together at 340 T/m with S-twist to form a hybrid cord (1670×1 polyketone+1440×1 polyester).

A further illustrative hybrid cord used in the strength element ply according to the present invention is a polyketone yarn having a linear density of 1670 dtex, Z-twisted at 350 T/m first twist, and a polyester yarn having a linear density of 1670 dtex, Z-twisted at 350 T/m first twist, were end-twisted together at 350 T/m with S-twist to form a hybrid cord (1670×1 polyketone+1670×1 polyester).

These cords have the properties shown in the table. Hybrid cords formed from polyketone and nylon are listed for comparison. Alternatively, the yarns can be S-twisted and the cord Z-twisted.

| | TABLE | | | |
|---|---|---|---|---|
| | Hybrid Cord | | | |
| | Polyketone | Polyketone | Polyketone | Polyketone |
| | (dtex 1670 × 1) + | (dtex 1670 × 1) + | (dtex 1670 × 1) + | (dtex 1670 × 1) + |
| | Polyester | Polyester | Nylon | Nylon |
| | (dtex 1440 × 1) | (dtex 1670 × 1) | (dtex 1400 × 1) | (dtex 940 × 1) |
| Breaking | 243 | 246 | 275 | 251 |
| force (N) | | | | |
| ASTM D 855 | | | | |
| Elongation | 10.8 | 10.3 | 11.8 | 13.6 |
| at break (%) | | | | |
| ASTM D 855 | | | | |
| Elongation | 3.7 | 3.2 | 4.5 | 5.9 |
| at 45 N (%) | | | | |
| ASTM D 855 | | | | |
| Shrinkage | 4.0 | 4.7 | 6.4 | 7.1 |
| at 180° C. (%) | | | | |
| ASTM D 855 | | | | |

It is evident that the hybrid cords formed from polyketone and polyester have a similar ASTM D 855 breaking force to the comparable hybrid cords formed from polyketone and nylon-6,6. The strength of the hybrid cords formed from polyketone and polyester thus appears to be comparable.

ASTM D 855 elongation at break is about 10 to 11% in the case of the hybrid cords formed from polyketone and polyester, while it is 11.33% and 13.58%, respectively, higher for the hybrid cords formed from polyketone and nylon. ASTM D 855 elongation at 45N for the hybrid cords formed from polyketone and polyester is merely 3.6% and 3.2% respectively, while it is respectively 4.46% and 5.94% for the hybrid cords formed from polyketone and nylon.

ASTM D 855 shrinkage at 180° C. is likewise more advantageous for the hybrid cords formed from polyketone and polyester compared with the hybrid cords formed from polyketone and nylon. While the hybrid cords formed from polyketone and nylon shrink by 6.37% and 7.13%, the hybrid cords formed from polyketone and polyester shrink by merely 4.0% and 4.7% respectively.

Therefore, the hybrid cord formed from polyketone and polyester provides a strength element ply for elastomeric articles of manufacture which has an approximately identical force transmission at low strain and thus not only for use in pneumatic vehicle tires, in particular for utility at high speeds, but also for further elastomeric articles of manufacture which are exposed to high mechanical stresses, for example conveyor belts, flat belts, flexible woven-fabric tubes, and air bellows.

Cost is another factor. The use of aramid yarn is more costly than the use of polyketone yarn which, furthermore, results in lower elongation at break and lower shrinkage.

1. A strength element ply for elastomeric articles of manufacture, comprising:
strength elements formed of hybrid cords disposed in a substantially parallel arrangement within the ply; and
said hybrid cords being formed of polyketone yarn forming a first twisted textile yarn and of polyester yarn forming a second twisted textile yarn;
wherein said first twisted textile yarn of polyketone and said second twisted textile yarn of polyester are end-twisted together.

2. The strength element ply according to claim 1, wherein said second twisted textile yarn is a polyester yarn selected from at least one member of the group consisting of polyethylene terephthalate (PET), polyethylene naphthalate (PEN), polybutylene terephthalate (PBT), and polycarbonate (PC).

3. The strength element ply according to claim 1, wherein said second twisted textile yarn has a linear density in a range from 400 to 2200 dtex.

4. The strength element ply according to claim 1, wherein said first twisted textile yarn has a linear density in a range from 400 to 2200 dtex.

5. The strength element ply according to claim 1, wherein at least one of said first twisted textile yarn and said second twisted textile yarn is end-twisted at 150 to 600 t/m to form a respective said hybrid cord.

6. The strength element ply according to claim 1, wherein at least one of said first twisted textile yarn and said second twisted textile yarn is end-twisted at 380 to 480 t/m to form a hybrid cord.

7. The strength element ply according to claim 1, wherein at least one of said first twisted textile yarn and said second twisted textile yarn comprise an adhesive impregnation enabling an adherence of said strength elements to rubber.

8. A method of manufacturing a pneumatic vehicle tire, comprising: providing a strength element ply according to claim 1 and integrating the strength element into the vehicle tire during a manufacture thereof.

9. A pneumatic vehicle tire, comprising a strength element ply according to claim 1 integrated into the vehicle tire.

10. The pneumatic vehicle tire according to claim 9, wherein said strength element ply is disposed as a belt bandage and/or as a bead reinforcer in the tire.

11. A conveyor belt comprising a strength element ply according to claim 1 integrated into the conveyor belt.

12. A flat belt comprising a strength element ply according to claim 1 integrated into the flat belt.

13. A flexible woven-fabric tube comprising a strength element ply according to claim 1 integrated into the flexible woven-fabric tube.

14. An air bellows comprising a strength element ply according to claim 1 integrated into the air bellows.
